(19) United States
(12) Patent Application Publication
(10) Pub. No.: US 2026/0264997 A1
(43) Pub. Date: Sep. 10, 2026

(54) MODULAR ROTATING DRUM TYPE CONVEYING SYSTEM

(71) Applicant: Suleyman SALIHLER, Ankara (TR)

(72) Inventor: Suleyman SALIHLER, Ankara (TR)

(21) Appl. No.: 19/489,279

(22) PCT Filed: Jun. 6, 2023
(86) PCT No.: PCT/TR2023/050530

§ 371 Date: Dec. 2, 2025

(51) Int. Cl. B65G 33/12; B65G 33/24; B65G 33/34

(52) U.S. Cl. CPC B65G 33/12; B65G 33/24; B65G 33/34; B65G 2207/30

(57) ABSTRACT

A modular and configurable rotating drum system used for conveying liquid and dry bulk material is provided. System is composed of several components that can be assembled to form a tailor made mechanical conveyor in a very simple manner. These components are mainly composed of rotating drums, mechanical locks connecting the rotating drums, screw flights, drive units and accessories. Having internal screw flights attached to the internal side of rotating drum and using external drive mechanisms makes it suitable for modular assembly of conveying system with respect to application needs.

### CROSS REFERENCE TO THE RELATED APPLICATIONS

This application is the national phase entry of International Application No. PCT/TR2023/050530, filed on Jun. 6, 2023, the entire contents of which are incorporated herein by reference.

### TECHNICAL FIELD

The present invention relates to a modular and configurable rotating drum system used for conveying liquid and dry bulk material. System is composed of several components that can be assembled to form a tailor made mechanical conveyor in a very simple manner. These components are rotating drums, flexible rotating drums, inlet, and outlet units, bearing units, motor drive units and accessories. Having internal flights attached to the internal side of rotating drum and using external drive mechanisms makes it suitable for modular assembly of conveying system with respect to application needs.

### BACKGROUND

Liquid pumping and bulk material conveying are common raw material handling methods. This includes collecting raw material from one or more locations and conveying them to one or more locations. Existing conveying and pumping systems are generally designed and manufactured for individual needs. For each project, a new pipeline or conveyor layout is designed, manufactured and assembled which requires extensive know how in the field. Engineering, production and installation costs might be high with respect to intended function.

As for liquid pumping, piping and supports should be designed and assembled with care. Pipe segments should be calculated and cut precisely before installation. Welding, flange and/or lug type connections, sealing are needed to obtain a problem free pipeline.

As for bulk solids conveying, screw feeders, belt conveyors, chain conveyors and elevators are the systems that are commonly used to transport bulk material. Each of them has limited functionalities. Screw feeders operate on straight conveying lines, horizontal, vertical or inclined. Handled material is pushed inside a tube against the wall which causes abrasion. To change the conveying direction (i.e. from horizontal to vertical) two screw feeders are need. Belt conveyors are suitable for long distance conveying but they are not suitable for vertical conveying and containment of dust is an issue. Chain conveyors can provide horizontal and vertical conveying but required energy consumption is high due to friction between scrapers and sliding surfaces. And there are issues due to frequently broken chains. Elevators are used for vertical conveying. The installation of elevators requires some amount of civil works also.

### SUMMARY

The objective of the present invention is to provide a modular mechanical conveying system for liquid and bulk solids that can be configured and assembled with respect to application needs.

A second object to provide a conveying system that can transport liquids and bulk solids in horizontal, vertical and inclined routes. Several routes can be combined in a single system.

Another object is to provide a conveying system that can have one or more material inlets and one or more material outlets at the same system.

Another object is to provide a conveying system that can transport liquids and bulk solids in low gravity or gravity free zones such as on space, on the moon, asteroids, space stations or low gravity celestial objects.

An additional object is to provide a conveying system that has improved abrasion resistance with respect to prior art systems.

A further object is to provide a conveying system that provides containment for handled materials to prevent dust emission and liquid leakage.

Another object is to provide a conveying system that can be adopted for any revisions or changes in conveying needs in the future.

Another object is to provide a reliable, low maintenance conveying solution by separating product flow from bearings and drive units.

Another object is to enhance energy efficiency by eliminating the excess forces generated during transportation, which are required to counteract internal frictions between stationary and moving parts.

Another objective is to safeguard delicate bulk materials during transportation by removing areas where stationary and moving parts coexist.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

FIG. 1 is a perspective view of the present invention showing main components.

FIG. 2 is a perspective view of the present invention showing a possible configuration with two material inlet units and one outlet unit.

FIG. 3 is a perspective view of the present invention showing operating principle on a possible configuration with one material inlet unit and one outlet unit.

FIG. 4 is a perspective view of the present invention showing a possible configuration with inlet at outlets at the tips of the assembled system through rotating drums.

FIG. 5A is a perspective exploded view of rotating drum, drive unit and support unit.

FIG. 5B is a perspective view of rotating drum, drive unit and support unit.

FIG. 6A is a perspective view showing opaque and transparent view of single rotating drums

FIG. 6B is a perspective view showing connection of the rotating drums

FIG. 7 is a cross sectional view of support unit

FIG. 8A is a perspective view of support unit

FIG. 8B is a cross section view of support unit

FIG. 9A is a perspective view of drive unit

FIG. 9B is a perspective view of drive units with gears

FIG. 9C is a perspective view of drive units with chain

FIG. 9D is a perspective view of drive units with belt

FIG. 10A is a perspective view of inlet unit

FIG. 10B is a perspective view of feeding drum/discharging drum

FIG. 11 is perspective and cross sectional view of inlet unit

FIG. 12 is perspective view of outlet unit

FIG. 13 is side view and cross sectional view of rotating drum and locking mechanism

FIG. 14 is a perspective view of rotating drum and locking mechanism

FIG. 15 is a perspective view of rotating drum and alternative locking mechanism

FIG. 16 is a cross sectional view of rotating drum and alternative locking mechanism

FIG. 17 is a perspective view of rotating drum and second alternative locking mechanism

FIG. 18 is a perspective view of rotating drum and closing cap

FIG. 19 is a perspective view showing alternative design of rotating drum with internal shaft.

FIG. 20 is a perspective view showing assembled flexible rotating drums

FIG. 21 is a cross sectional view showing internal air/gas injection design.

FIG. 22 is a perspective view showing assembly of structural elements to hold complete system together.

FIG. 23 is a perspective view showing assembly of half rotating drums to form a single rotating drum.

FIG. 24 is a perspective view showing rotating drum with magnetic lock.

FIG. 25 is a perspective view showing polygonal and elliptical rotating drums.

FIG. 26 is a perspective view showing rotating drum in the shape of curved hollow circular tube.

### PART REFERENCES

1. Rotating drums
3. Screw flight
4. Mechanical lock
5. Axis of drums
6. Bearing
7. Bushing
8. Sleeve
9. Support unit
10. Hollow shaft
11. Drive unit
13. Motor
14. Pinion gear
15. Ring gear
16. Bearing housing
17. Chain gear(small)
18. Chain gear(big)
19. Chain
20. Belt pulley
21. V belt/timing belt
22. Feeding/discharging drum
23. Driving pulley
25. Short tube
27. Supporting rod
28. Inlet unit
29. Inlet opening
30. Magnet
31. Surface Groove
32. Outlet unit
33. Outlet opening
35. Thread
36. Circular offset
37. Latch clips
38. Circular recess
39. Latch clips recess
40. half circular offset
42. Hole
43. Half circular recess
44. Grooves
45. Screw hole
46. Screws
47. Flange
48. Flange holes
49. Nut
50. Bolt
51. Washer
52. Flange screw hole
53. Closing cap
54. Internal shaft
55. Elbow drum
56. Flow channel
57. Injection holes
58. Supporting structure
59. Rectangular Flange
60. Drum Pieces
61. Polygonal drum
62. Elliptical drum
63. Curved drum

### DETAILED DESCRIPTION OF THE EMBODIMENTS

The present invention has a modular design mainly composed of rotating drums (1), mechanical locks(4) connecting the rotating drums(1), screw flights(3), drive units (11) and accessories.

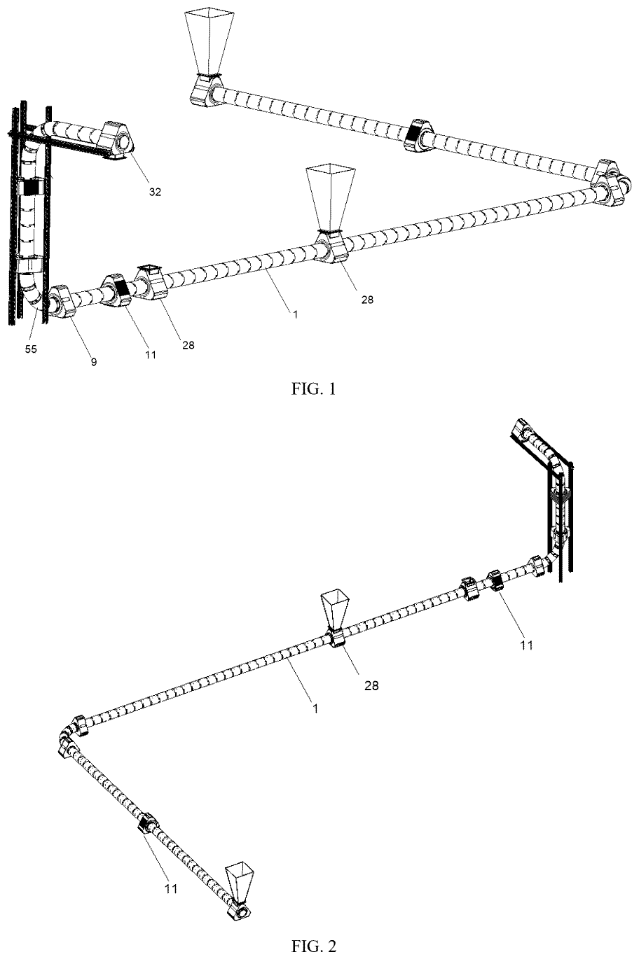

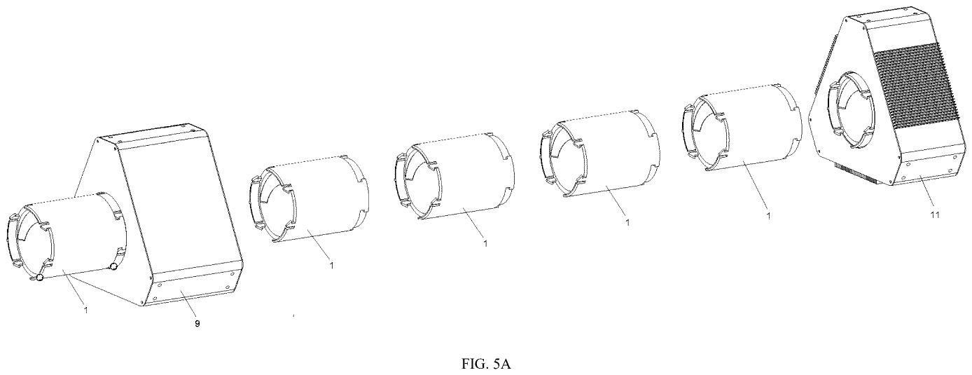

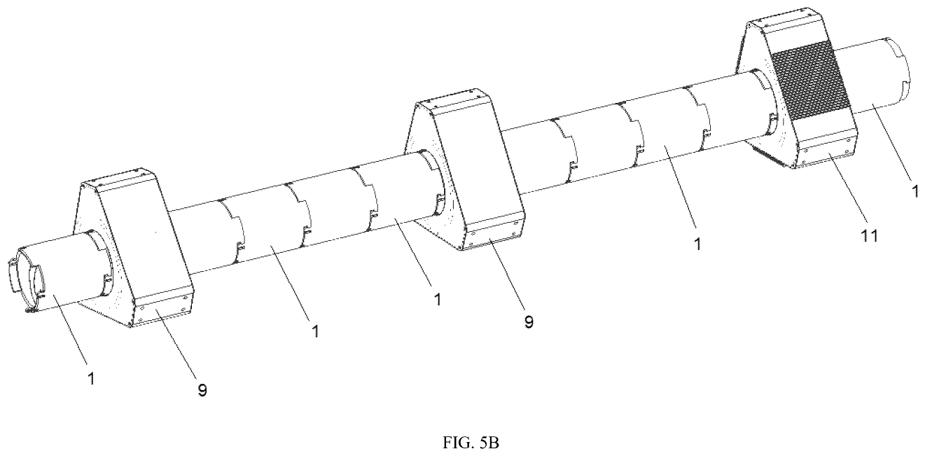

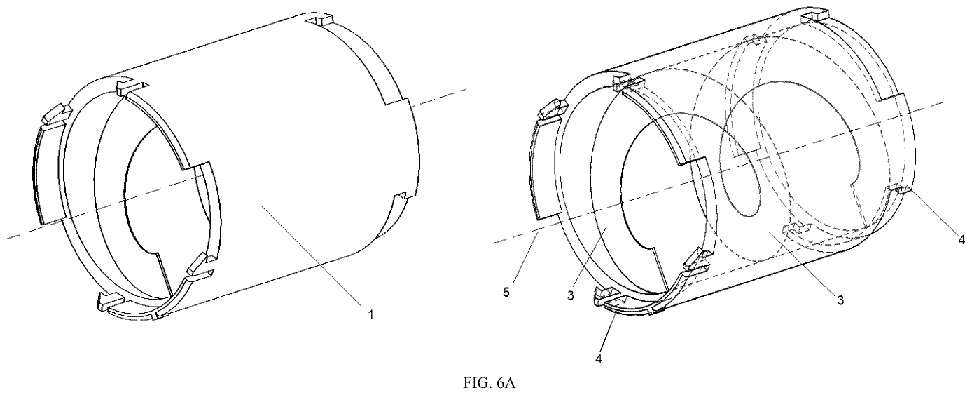

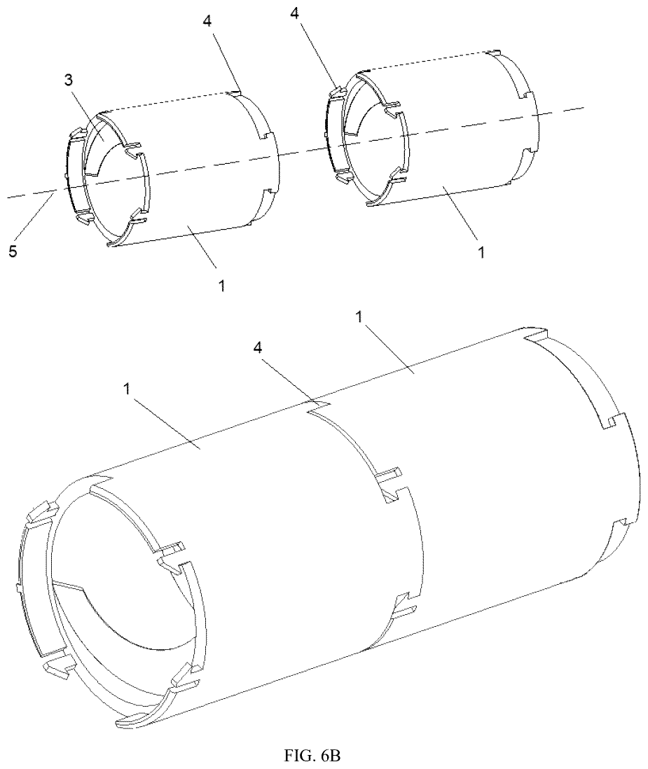

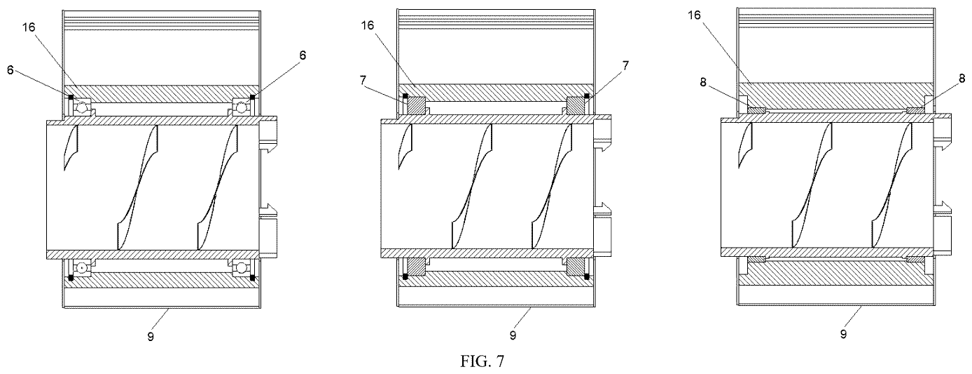

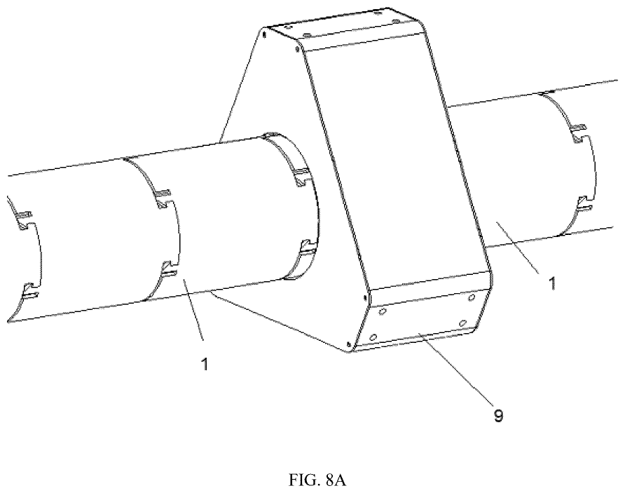

Rotating drums (1) have a shape of hollow circular tube. Inside the tube, there exist helical flights (3) which are attached to internal surface of the tube leaving the center of tube empty as shown in FIGS. 6A-6B. Rotating drums(1) and helical flights(3) may be monolithic in one piece. Material to be handled enters the rotating drum(1) from one side, when drum(1) rotates around its own axis (5), the helical flights (3) push the material towards the other side. The aim of rotation of drum(1) is conveying bulk solids and liquids between two ends of rotating drums (1). Rotating drums (1) can be attached to each other along their rotational axis (5). End of the each screw flight(3) attached to the rotating drum(1) is adjacent to the beginning of the next screw flight(3) attached to the next rotating drum(1) offering integrated continuous helical structure. Each outlet side of the rotating drum (1) matches perfectly to the inlet side of counter rotating drum (1). Different types of mechanical locks (4) can be used to attach and fix two rotating drums (1) to each other. Assembling of several rotating drums (1) together makes it possible to obtain an integrated continuous helical structure inside the rotating drums (1) and to obtain a long conveying system to convey materials to longer distances as shown in FIGS. 1-4. The material can be fed into the whole conveying system through inlet end of first rotating drum (1) and the material can be taken from outlet end of last rotating drum(1). To move the material inside the rotating drums (1), a drive unit(11) is used. Drive units (11) are used to turn the drums(1) around their axis (5) convey the material inside. Rotating drums(1) may be made of flexible materials such as rubber, polyurethane, textile fabric etc.

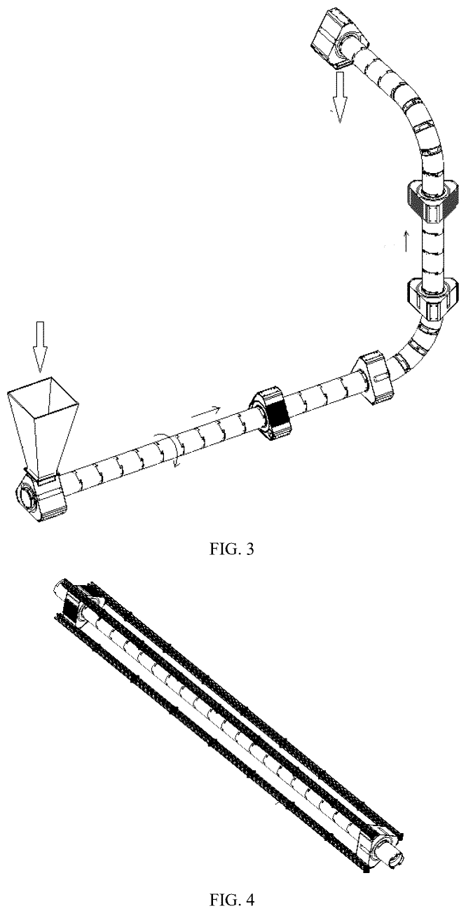

Alternative type of rotating drum (1) is made of flexible material such as rubber, polyurethane, silicone etc. which is preferably used in the corners and mentioned as elbow drum (55) as shown in FIG. 20. The elbow drum (55) can be bended along its rotating axis (5). Using one or more elbow drums (55) together makes it possible to have a directional change in material flow. For example material can be pushed in one direction and then diverted 90 degrees during conveying by using elbow drums (55) as shown in FIG. 3.

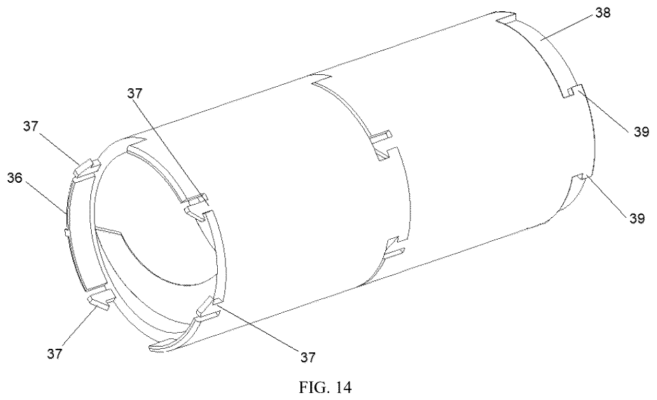

Both ends of the rotating drums (1) has special design for locking the rotating drum (1) to another one mechanically. There exist several different designs to lock two rotating drums (1) to each other. In the first design, one side of the rotating drum (1) has a hollow circular offset (36) with same external diameter of rotating drum (1) and increased internal diameter than the rotating drum (1) at the tip and the other side has a counter circular recess (38) having smaller external diameter than rotating drum (1), Internal diameter of hollow circular offset (36) at one side is the same as external diameter of hollow circular recess (38) at the other side. In this way two rotating drums (1) can be attached to each other by inserting one side to the other side. Latch clips (37) on opposing sides are used to lock the two rotating drums (1) as shown in FIG. 14.

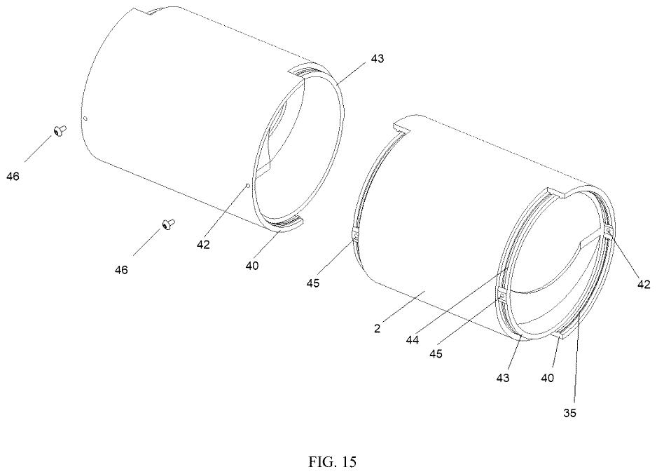

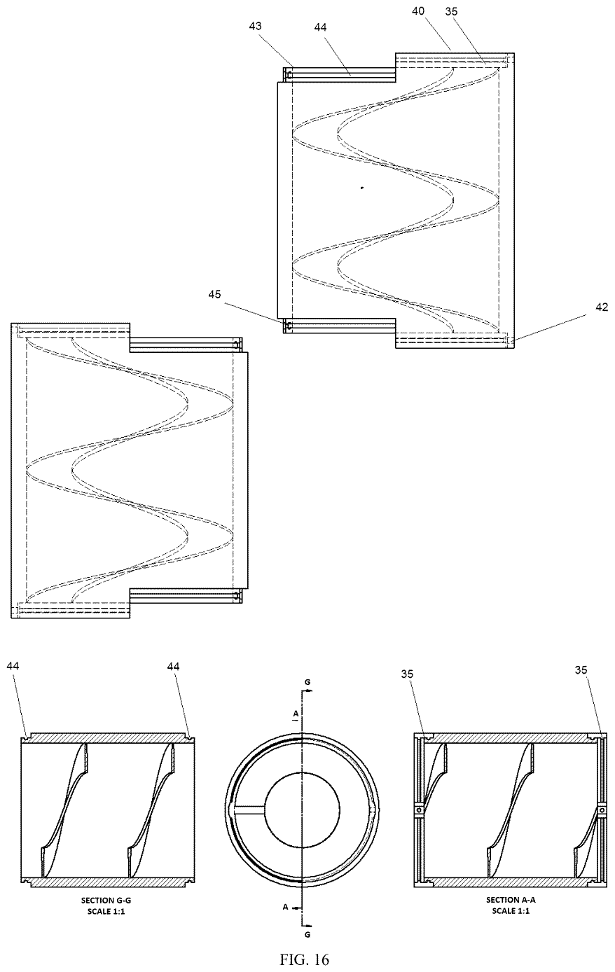

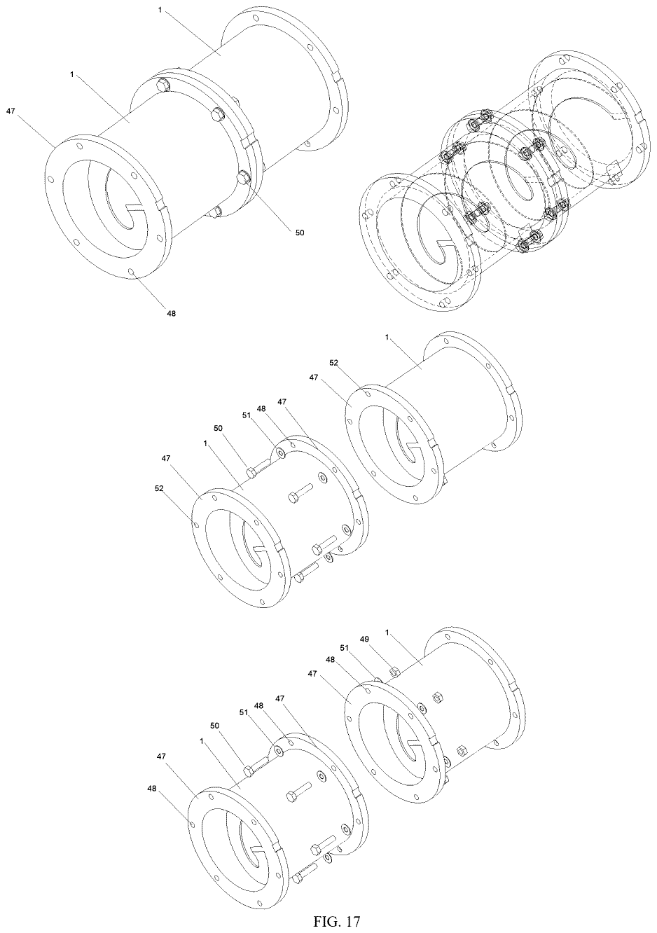

In another configuration, an external half circular offset (40) at one end of the rotating drum (1) has the same external diameter of rotating drum (1) and internal surface of the circular offset (40) has threads (35) to lock the rotating drum (1) to countering rotating drum (1). Other half of the same end of rotating drum (1) has half circular recess (43) and grooves (44) on the external surface on the circular recess (43). When two rotating drums (1) are faced to each other, half circular offset (40) and half circular recesses (43) match each other. Grooves (44) and threads (35) also match each other to provide a strong mechanical lock (4). A hole (42) at the half circular offset (40) and a screw hole (45) at half circular recess (43) are aligned when two rotating drums (1) are attached. A set of screws (46) are inserted through the holes (42) and screwed to screw holes (45) to fix two rotating drums (1) together as shown in FIG. 15.

The third design of assembling two drums(1) is using flange connections at both ends. Flanges (47) have flange holes (48) around the axis. When two rotating drums (1) are placed side by side, the flanges (47) and flange holes (48) also match. Rotating drums (1) are fixed to each other by using nuts (49), bolts (50), and washers (51) through the stated flange holes (48).

A fourth design of assembling two drums is using magnets(30) attached to both ends of rotating drums (1). Magnets(30) of one side of rotating drum (1) attract the magnets(30) of one side of the other rotating drum (1) as shown in FIG. 24. When two rotating drums (1) are hold together, said magnets(30) provide a strong magnetic lock.

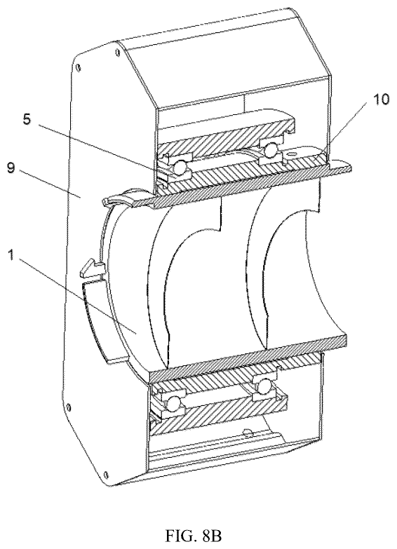

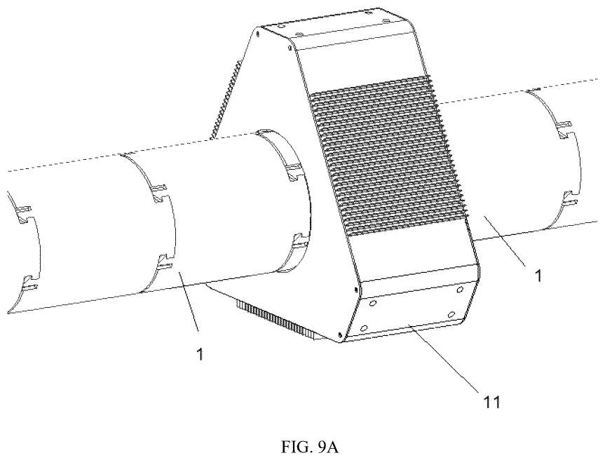

To hold a conveying system composed of several rotating drums (1), support units (9) could be used as shown in FIGS. 8A-8B. Support units (9) include one or more bearings(6) inside. The outer shell of bearings(6) are installed inside the bearing housing (16) which is fixed inside the body of support unit (9). The inner shell of bearings(6) hold the rotating drum (1) and allows it to rotate freely inside the support unit (9). Bushings (7) or sleeves (8) can also be used instead of bearings(6). There also exist a large diameter hollow shaft (10) attached inside bearings (6) or bushings (7) or sleeves (8), and rotating drum (1) attached inside the hollow shaft (10) can rotate freely around its own axis(5). The support units (9) can be fixed to any external structure, basement, wall, ceiling etc. The rotating drum (1) inside the support unit (9) is connected to other rotating drums (1). Using several support units (9) together and assembling several rotating drums (1) between the support units (9) makes it possible to obtain a conveying system with any length and route. Bulk solid and/or liquid material enters from one side of conveying system and exits through the other side.

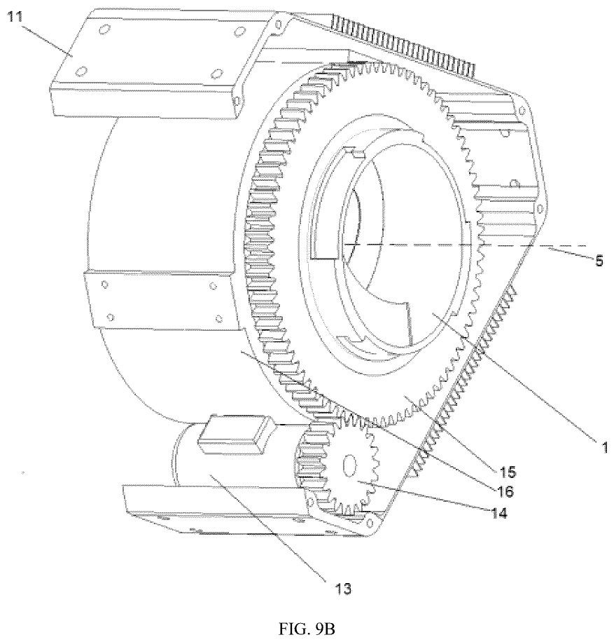

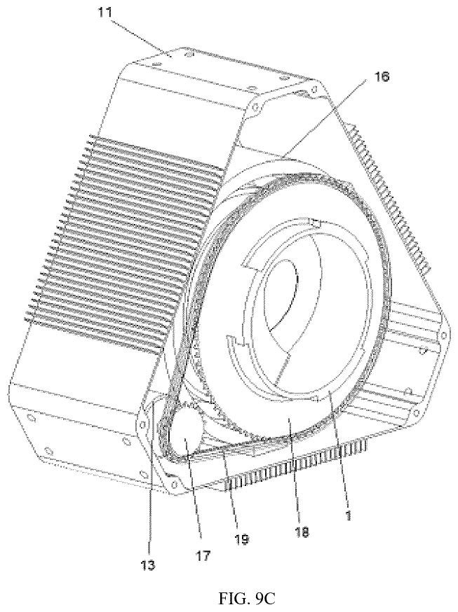

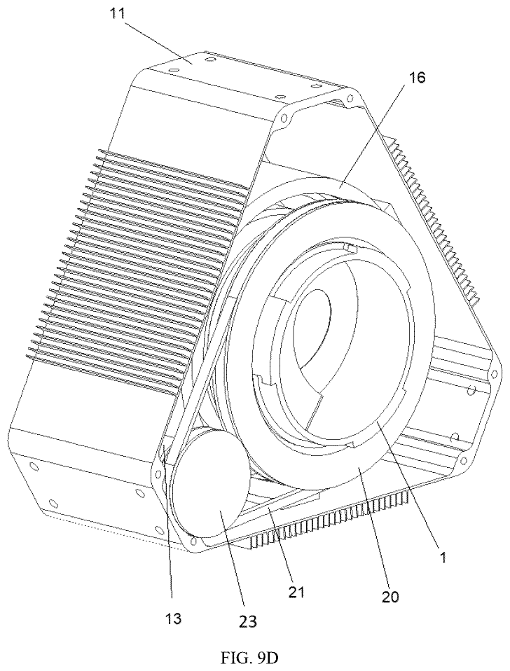

To rotate a chain of several rotating drums (1) assembled together, there needs to be a drive unit(11) as shown in FIGS. 9A-9D, Drive units (11) preferably have the same outer design with support units (9). Two bearings(6) are installed inside the bearing housing (16) which is fixed inside the drive unit(11). The two bearings(6) hold the rotating drum (1) assembled inside them. The rotating drum (1) inside the bearing (6) has a ring gear (15) around it. Bushings (7) or sleeves (8) can also be used instead of bearings(6). A motor (13) having a pinion gear (14) on its shaft is fixed inside the support unit (9). The pinion gear (14) on the motor (13) is used to turn the ring gear (15) around the rotating drum (1). Rotating drum (1) of drive unit(11) is used to transmit rotational motion to other rotating drums (1) attached to it. So when the motor (13) is operated, the pinion gear (14) on the motor (13) turns ring gear(15) affixed to the rotating drum (1) and it turns the other connected rotating drums (1). Using a drive unit(11) and several support units (9) together and assembling several rotating drums (1) between the support units (9) or driving units(11) makes it possible to obtain a conveying system with any length and route. Bulk solid and/or liquid material enters from one side of conveying system and exits through the other side.

In certain applications, drive units (11) could also be used instead of support units (9) and there will be no need for support units(9) Since motor units(11) also acts as a supporting element.

To obtain different rotation speeds and higher torques a gearbox can also be installed in front of the motor (13). Motor (13) drives the gearbox and gearbox has a pinion gear (14) on its output shaft. The pinion gear (14) turns the ring gear (15) installed on the rotating drum (1).

Another driving mechanism is using chain gears (17,18). A chain gear(small) (17) is installed on motor (13) shaft. And another ring type chain gear(big) (18) is assembled around the rotating drum (1) of drive unit. A chain (19) is used to transmit power from one chain gear (small)(17) to the other. When the motor (13) is operated, the rotating drum (1) turns around its own axis (5). Again a gearbox can also be installed in front of the motor (13) and chain gear(small)(17) can be installed on output shaft of gearbox to achieve different rotational speeds and torques.

Another driving mechanism is using V-belts (21) and belt pulleys (20). A driving pulley (23) is installed on motor (13) shaft. And another ring type belt pulley (20) is assembled around the rotating drum (1) of drive unit(11). A V-belt (21) is used to transmit power from driving pulley (23) to the other belt pulley (20) attached around the rotating drum (1). When the motor (13) is operated, the rotating drum (1) turns around its own axis (5). Again a gearbox can also be installed in front of the motor (13) and driving pulley (23) can be installed on output shaft of gearbox to achieve different rotational speeds and torques. A timing belt(21) and suitable pulleys can also be used instead of V-belt(21).

Another driving mechanism is using a series of independent electrical windings and magnets. Electrical windings are positioned around the rotating drum (1), and fixed to the internal surface of housing of the drive unit(11). Additionally a series of magnets attached around the rotating drum (1). When electrical current is applied sequentially to the windings, the generated and rotating magnetic force is used to rotate the drums(1).

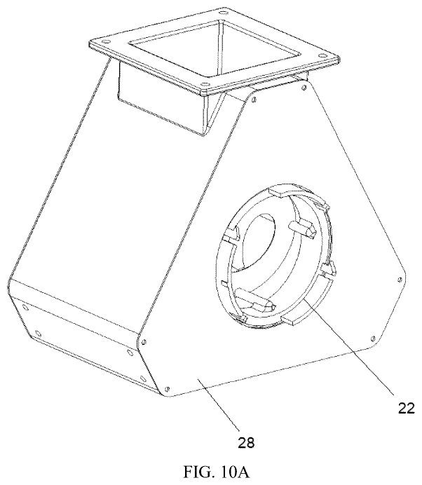

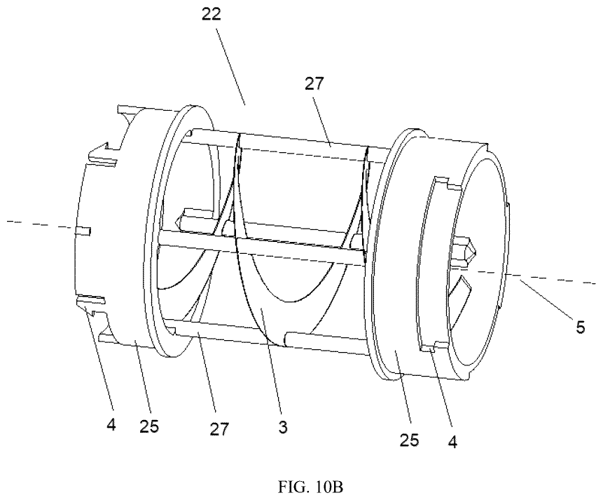

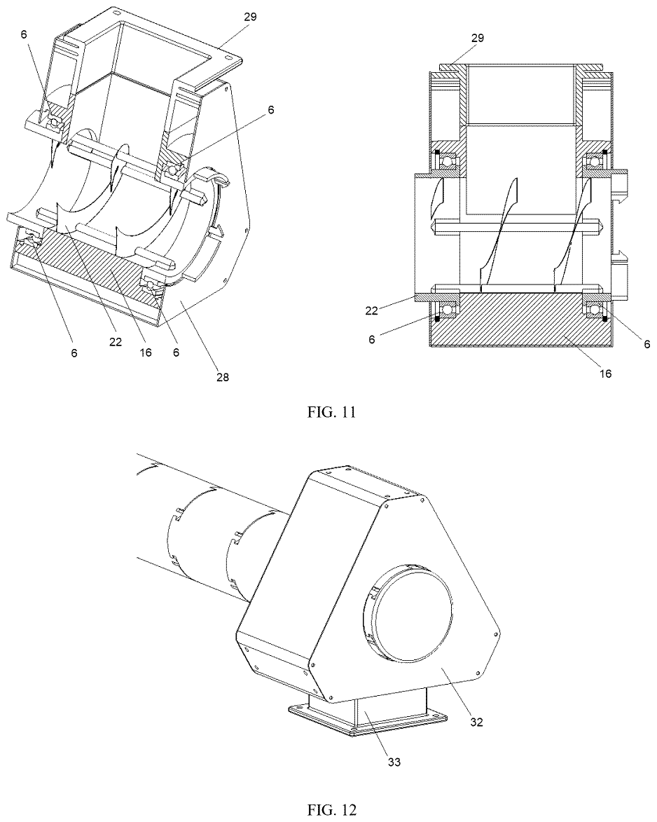

Instead of feeding bulk material and liquid from one end of the rotating drum (1), an inlet unit (28) can be used to feed the conveying system from any point along the route as shown in FIGS. 10A-11. Inlet units(11) include an inlet opening(29) and two bearings(6) inside. The outer shell of bearings(6) are fixed to the bearing housing (16) inside the body of the inlet unit (28). The inner shell of bearings holds the feeding/discharging drum(22) and allows it to rotate freely inside the inlet unit (28). Feeding/discharging drum(22) has an inlet passage, opening or hollow part perpendicular to the rotation axis(5) and bulk solids or liquids feed in the inlet opening(29) can move directly into the center of screw flight (3). In other words The feeding/discharging drum(22) does not have an outer tube, instead it is composed of helical flights(3) only so that bulk material and liquid can move from its outer diameter to the center. Bulk solids or liquids reaching the center of the screw flights(3) can move to the conveying direction by rotation of the screw flight (3) around it's own axis(5) Two hollow circular short tubes (25) attached to both ends of the screw flight (3), and there are two mechanical locks (4) at the ends of each hollow circular short tube (25). The two circular short tubes (25) and rotating drums (1) are attachable to each other by using the mechanical lock (4). Furthermore a set of supporting rods(27) are attached to the screw flight (3) to provide a single rigid structure for the feeding/discharging drum (22) to handle any force exerted on the feeding/discharging drum (22) and provide inlet/outlet passage for the material perpendicular to the rotation axis(5) of the drum. Bushings (7) or sleeves (8) can also be used instead of bearings(6). The inlet unit (28) can be fixed to any external structure, basement, wall, ceiling etc. The feeding/discharging drum(22) inside the inlet unit (28) is connected to other rotating drums (1). The feeding/discharging drum(22) does not have an outer tube, instead it is composed of helical flights (3) only so that bulk material and liquid can move from its outer diameter to inner center. Rotation of the feeding/discharging drum(22) pushes the material along its axis (5).

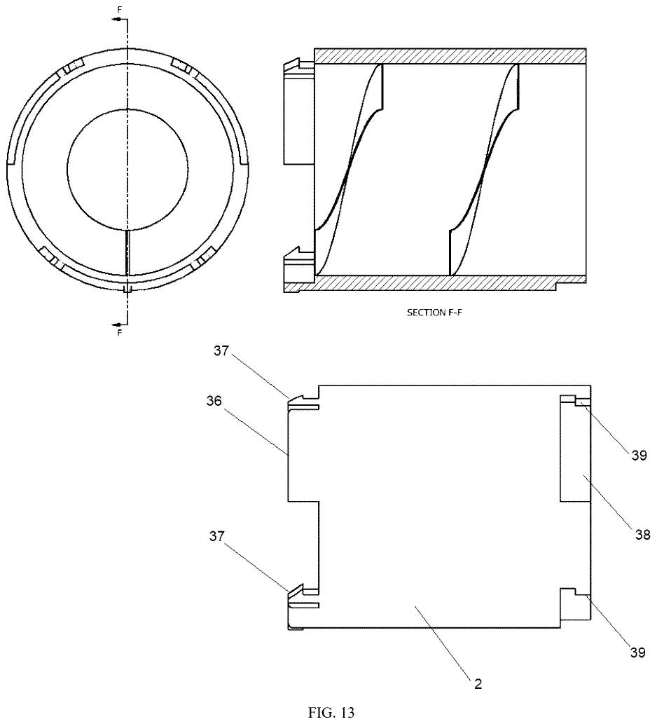

Outlet units (32) are used to discharge the handled material at any point along the conveying route as shown in FIG. 12. Outlet units (32) include two bearings(6) inside. The outer shell of bearings(6) are fixed to the bearing housing (16) inside the body of outlet unit (32). The inner shell of bearings(6) hold the feeding/discharging drum(22) and allows it to rotate freely inside the inlet unit (28). Bushings (7) or sleeves (8) can also be used instead of bearings(6). The outlet unit (32) can be fixed to any external structure, basement, wall, ceiling etc. The feeding/discharging drum(22) inside the outlet unit (32) is connected to other rotating drums (1). Feeding/discharging drum(22) has an outlet passage, opening or hollow part perpendicular to the rotation axis(5) and bulk solids or liquids moving in the rotating drums(1) can move from its inner center to outer diameter trough outlet opening(33) In other words The feeding/discharging drum(22) does not have an outer tube, instead it is composed of helical flights(3) only so that bulk material and liquid can move from its inner center to outer diameter. The feeding/discharging drum(22) does not have an outer tube, instead it is composed of helical flights(3) only so that bulk material and liquid can move from its inner center to outer diameter. Rotation of the feeding/discharging drum(22) pushes the material along its axis (5) and allows the material fall down through the outlet openings(33) around its circumference.

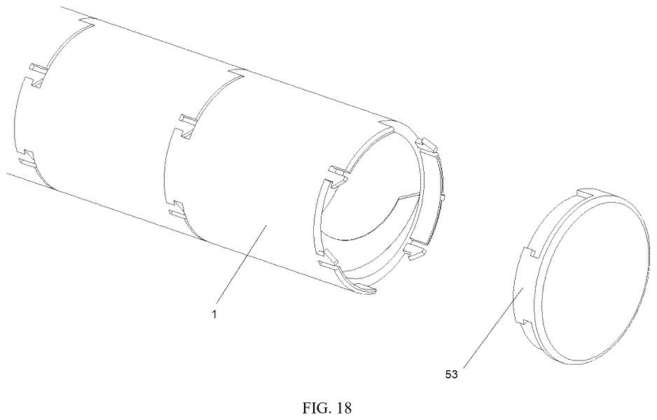

Closing caps (53) are used to close the both ends of complete conveying system whenever needed as shown in FIG. 18. Closing caps (53) can have one of the four same mechanical locks (4) stated above to be locked and close one end of rotating drums (1).

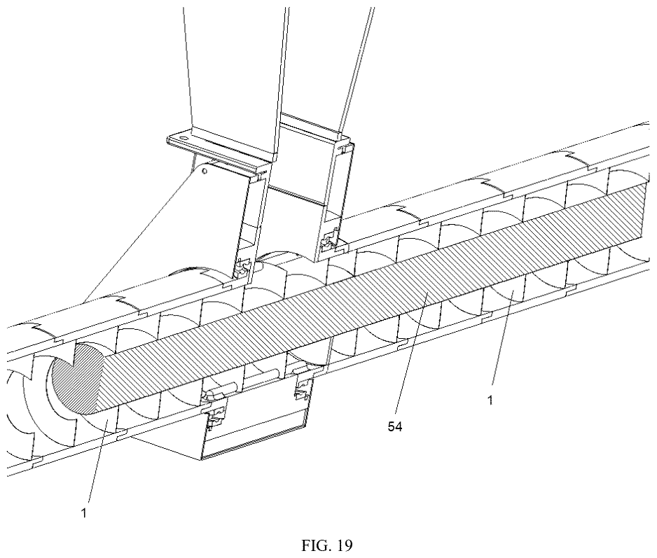

To facilitate the conveying of handled bulk solids or liquids and stabilize the full system, axial center of rotating drum (1) can be closed by a shaft (54). This shaft (54) can be fixed as an integral part of rotating drum (1) and can rotate together with rotating drum (1). Or it can be an independent separate part and can stay stationary while the rotating drum (1) is rotating as shown in FIG. 19.

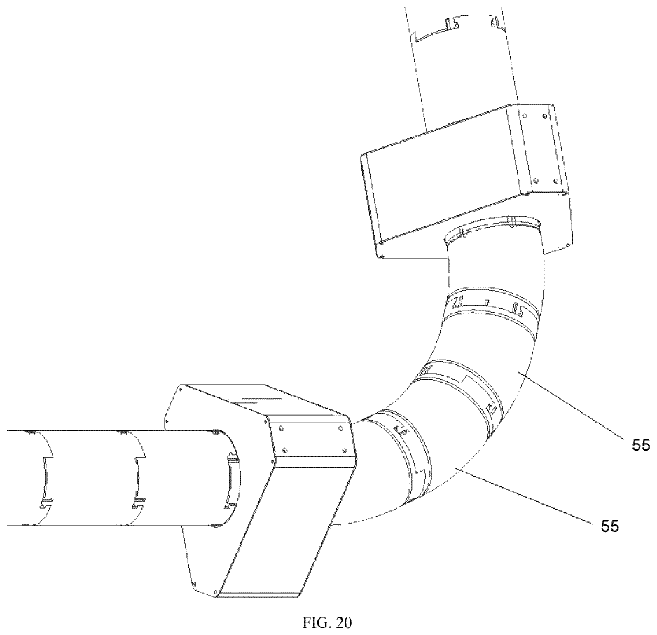

Depending on the characteristics of conveyed material, some gases or liquids need to be injected into the internal side of rotating drums (1) or in some cases gases, liquids needed to be sucked from the internal side of rotating drums (1). To enable these functionalities, flow channels (56) are used which are placed inside the outer shell of rotating drums (1). When several rotating drums (1) are assembled together, said flow channels (56) become aligned and form a continuous channel. Internal tubular injection holes (57) are used to connect the flow channels (56) to internal side of rotating drums (1) as shown in FIG. 21.

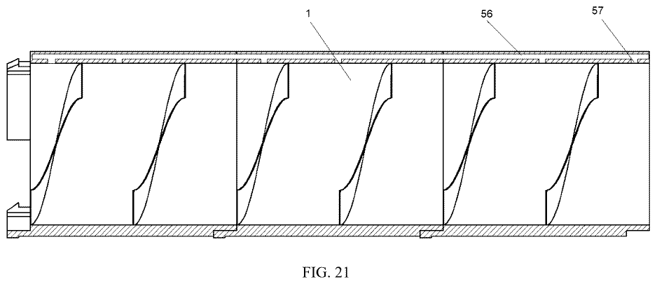

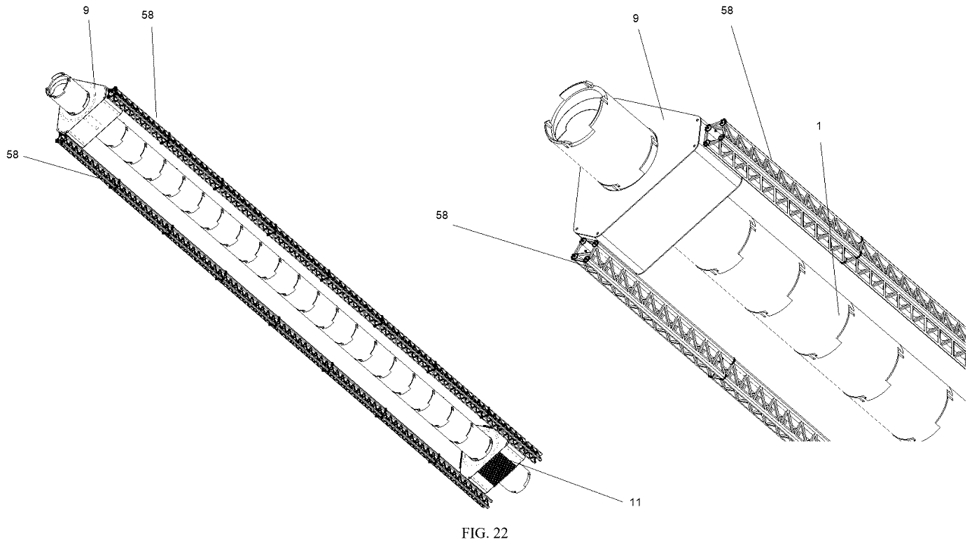

A supporting structure (58) is used to hold a complete assembly of rotating drums (1), support units (9), drive units (11), inlet units (28), outlet units (32) and possible further mechanical components together as shown in FIG. 22. The supporting structure (58) can also be used to fix the components to buildings, walls, ceilings, basements etc. to form a rigid structure.

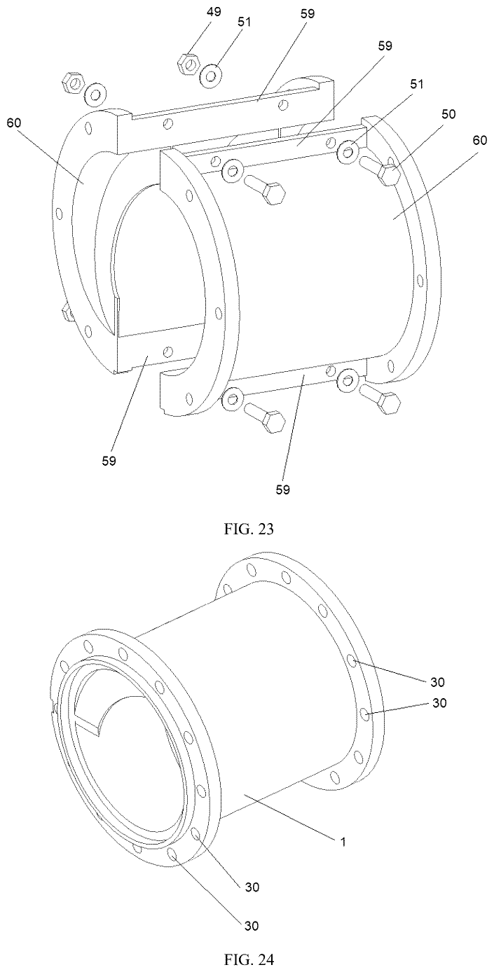

Rotating drums (1) can be designed in such a way that, they can be splitted in two drum pieces(60) for ease of assembly and disassembly as shown in FIG. 23. Each drum pieces(60) has the same shape of one half of the rotating drum (1) that is cut along its rotation axis (5). To enable such functionality, a locking mechanism in any shape and/or orientation can be used. A simplest way of achieving this functionality is splitting the rotating drum (1) into two drum pieces(60) along its rotational axis (5). The two drum pieces(60) are preferably connected to each other by using flange holes (48) on rectangular flanges (59), nuts (49), bolts (50), and washers (51). The rectangular flanges(59) and the flange holes (48) of two facing half rotating drums (60) align and match each other so that nuts (49), bolts (50) and washers (51) can be used to fix the drum pieces(60) to each other to achieve a single part of rotating drum(1).

Rotating drum (1) according to this invention may be in the shape of Polygonal drum(61), elliptical (62) or any cross sectional shape of hollow tube such as curved drum(63) instead of hollow circular tube. The diameter of Curved drum (63) is not constant and changes several times along the rotation axis (5).

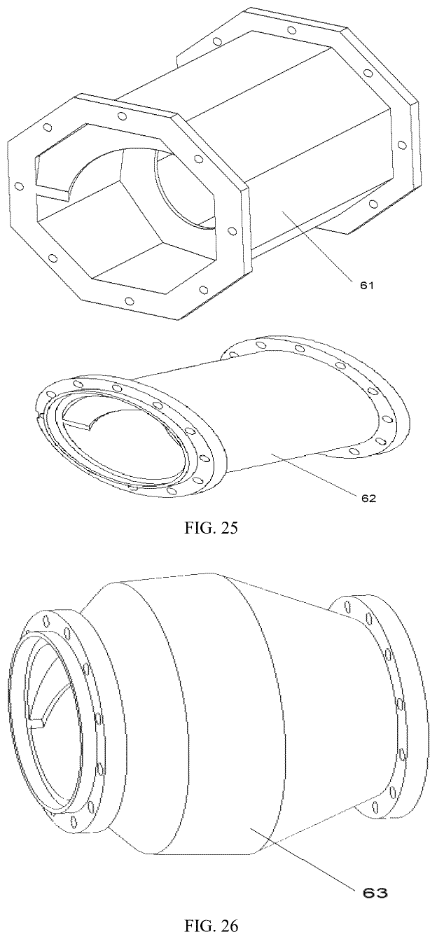

Depending on type of application and handled material, cross sectional shape of hollow circular tube of the rotating drums(1) may be different from circle. Rectangular, polygonal, elliptical cross sections are also possible as shown in FIG. 25. Helical flights (3) are still attached to internal surface of the drums and main functionality of rotating drum (1) remains unchanged.

Depending on type of application and handled material, the diameter of hollow circular tube may change along the axis (5) of rotating drum (1) as shown in FIG. 26.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting

What is claimed is:

1. A modular mechanical conveying system for conveying bulk solids and/or liquids, comprising:
a set of rotating drums monolithic in one piece and in a form of a hollow circular tube attached to each other to form a conveying line, wherein a number of the rotating drums and orientations are changed depending on a conveying distance, an inlet location, and an outlet location;
a screw flight monolithic in one piece and attached to an internal side of each of the rotating drums to move the bulk solids and/or liquids along an axis of each of the rotating drums by rotating the rotating drums around the axis of each of the rotating drums: wherein an end of the each screw flight attached to each of the rotating drums is adjacent to a beginning of a next screw flight attached to a next rotating drum offering an integrated continuous helical structure;
a mechanical lock at two ends of each of the rotating drums, to attach two rotating drums; and
at least one drive unit for providing support and rotational motion to the rotating drums, wherein a number of the at least one drive unit and locations are changed depending on the conveying distance, the inlet location, and the outlet location.

2. (canceled)

3. (canceled)

4. (canceled)

5. The modular mechanical conveying system for conveying the bulk solids and/or liquids according to claim 1, wherein the at least one drive unit having a motor further comprises a power transmission part comprising:
a pinion gear installed on the motor or a gearbox shaft;
at least one bearing and a bearing housing to hold each of the rotating drums; and
a ring gear attached around each of the rotating drums, wherein the pinion gear is configured to rotate the ring gear and each of the rotating drums;
or
a small chain gear installed on the motor;
a set of bearings and the bearing housing to hold each of the rotating drums;
a big chain gear attached around each of the rotating drums; and
a chain, wherein the small chain gear on the motor is configured to rotate each of the rotating drums together with the big chain gear around each of the rotating drums;
or
a driving pulley installed on the motor or a gearbox;
the set of bearings and the bearing housing to hold each of the rotating drums;
a belt pulley attached around each of the rotating drums; and
a v-belt/timing belt, wherein the driving pulley on the motor is configured to rotate each of the rotating drums together with the belt pulley around each of the rotating drums;
or
a series of independent electrical windings positioned around each of the rotating drums, and fixed to an internal surface of a housing of the at least one drive unit; and
a series of magnets attached around each of the rotating drums, wherein when electrical current is applied sequentially to the series of independent electrical windings, generated and rotating magnetic force is configured to rotate the rotating drums.

6. (canceled)

7. (canceled)

8. (canceled)

9. The modular mechanical conveying system for conveying the bulk solids and/or liquids according to claim 1, further comprising at least one support unit, wherein the at least one support unit comprises:
at least one bearing or a bushing or a sleeve, wherein the at least one bearing or the bushing or the sleeve are attached inside a support unit housing; and
a large diameter hollow shaft attached inside bearings or bushings or sleeves, and a rotating drum attached inside the large diameter hollow shaft, wherein the rotating drum rotates freely around the axis of the rotating drum.

10. The modular mechanical conveying system for conveying the bulk solids and/or liquids according to claim 1, further comprising:
an inlet unit having an inlet opening and/or an outlet unit having an outlet opening, wherein each of the inlet unit and the outlet unit comprises:
at least one bearing;
a bearing housing;
a feeding/discharging drum having the screw flight, wherein the feeding/discharging drum has an inlet passage perpendicular to a rotation axis; and
a closing cap.

11. The modular mechanical conveying system for conveying the bulk solids and/or liquids according to claim 10, wherein the feeding/discharging drum comprises:
the screw flight having the inlet passage, an opening or a hollow part allowing the bulk solids or liquids to move from sides of the screw flight into a center of the screw flight, wherein rotation of the screw flight around an axis of the screw flight pushes the bulk solids or liquids along a conveying direction;
two hollow circular short tubes attached to both ends of the screw flight;
two mechanical locks at ends of each of the two hollow circular short tube having the mechanical lock to connect other rotating drums; and
a set of supporting rods attached to the screw flight and two hollow circular short tubes providing a single rigid structure for the feeding/discharging drum to handle any force exerted on the feeding/discharging drum and provide the inlet passage for a material perpendicular to the rotation axis of the feeding/discharging drum.

12. (canceled)

13. (canceled)

14. The modular mechanical conveying system for conveying the bulk solids and/or liquids according to claim 1, wherein the mechanical lock comprises:
a hollow circular offset with a same external diameter of each of the rotating drums;
a set of latch clips attached to an end of the hollow circular offset;
a counter hollow circular recess having a smaller external diameter of each of the rotating drums; and
a latch clips recess attached on an outer surface of the counter hollow circular recess to lock the latch clips recess attached to an outer diameter of a counter circular hollow tube.

15. The modular mechanical conveying system for conveying the bulk solids and/or liquids according to claim 1, wherein the mechanical lock comprises:
an external half circular offset at a first end of each of the rotating drums with a same external diameter of each of the rotating drums, wherein an internal surface of the external half circular offset has threads to lock each of the rotating drums to countering each of the rotating drums;
a hole at a middle point of the external half circular offset, wherein the hole begins from an external surface of the external half circular offset, ends to the internal surface of the external half circular offset, and a hole axis is perpendicular to each of the rotating drums;
an internal half circular recess at a second end of each of the rotating drums with a same internal diameter of each of the circular rotating drums, wherein an external surface of the internal half circular recess has grooves to lock each of the rotating drums to countering each of the rotating drums, wherein the threads match the grooves;
a screw hole at a middle point of the internal half circular recess, wherein the screw hole begins from the external surface of the internal half circular recess, ends just before the internal surface of the external half circular offset, and a thread axis is perpendicular to each of the rotating drums; and
a set of screws to fix the two rotating drums to each other by using the screw hole and the thread.

16. The modular mechanical conveying system for conveying the bulk solids and/or liquids according to claim 1, wherein the mechanical lock comprises:
two circular flanges at both ends of each of the rotating drums;
a plurality of flange holes on a surface of each of the two circular flanges;
nuts;
bolts; and
washers, wherein the two circular flanges and the plurality of flange holes of two facing rotating drums align and match each other, wherein the nuts, the bolts, and the washers are configured to fix the two facing rotating drums to each other to achieve a concentric assembly with sealing.

17. (canceled)

18. The modular mechanical conveying system for conveying the bulk solids and/or liquids according to claim 1, further comprising a shaft either attached and fixed to a center of each of the rotating drums wherein the shaft rotates together with each of the rotating drums, or placed the center of each of the rotating drums without fixation to each of the rotating drums.

19. (canceled)

20. The modular mechanical conveying system for conveying the bulk solids and/or liquids according to claim 1, further comprising an elbow drum for changing a conveying direction at any angle, wherein the elbow drum is made of flexible materials comprising rubber, polyurethane, and textile fabric, and in the form of hollow circular tube, and the screw flight is attached to an internal side of each elbow drum to move the bulk solids and/or liquids along an axis of the elbow drum by rotating the elbow drum around the axis of the elbow drum.

21. (canceled)

22. The modular mechanical conveying system for conveying the bulk solids and/or liquids according to claim 1, wherein each of the rotating drums further comprises:
a flow channel having internal tubular injection holes to have a shape of an internal pipe from end to end along the axis of each of the rotating drums; and
the internal tubular injection holes, wherein the internal tubular injection holes are connected and perpendicular to the flow channel to inject or suck any gas or liquid inside the flow channel into a space inside each of the rotating drums.

23. The modular mechanical conveying system for conveying the bulk solids and/or liquids according to claim 1, further comprising a supporting structure to hold a weight of a complete conveying system by connecting a support unit, the at least one drive unit, an inlet unit, an outlet unit, and possible further mechanical components to each other and any external surface or building.

24. The modular mechanical conveying system for conveying the bulk solids and/or liquids according to claim 1, wherein the mechanical lock comprises:
two circular flanges at both ends of each of the rotating drums;
a plurality of magnets on a surface of each of the two circular flanges, wherein each of the two circular flanges of the two rotating drums and the plurality of magnets align and match each other, while the plurality of magnets of counter flanges attract each other to provide enough force to allow a rigid assembly of two or more rotating drum; and
surface grooves on flange surfaces of each of the rotating drums to allow axial alignment of each of the rotating drums while assembling the rotating drums by the plurality of magnets.

25. The modular mechanical conveying system for conveying the bulk solids and/or liquids according to claim 1, wherein each of the rotating drums is alternatively made of two drum pieces, wherein the two drum pieces match and attached to each other by any method of mechanical fixing to form a single piece of the rotating drum.

26. (canceled)

27. The modular mechanical conveying system for conveying the bulk solids and/or liquids according to claim 1, wherein each of the rotating drums is in a form of a Polygonal drum, an elliptical drum or a curved drum instead of the hollow circular tube, and a diameter of each of the rotating drums or an out size of each of the rotating drums changes along the axis of each of the rotating drums.

28. (canceled)
